(19) United States
(12) Patent Application Publication
(10) Pub. No.: US 2026/0080129 A1
(43) Pub. Date: Mar. 19, 2026

(54) NON-TRANSITORY COMPUTER-READABLE MEDIUM, CALCULATION METHOD, AND INFORMATION PROCESSING DEVICE

(71) Applicant: Fujitsu Limited, Kawasaki-shi (JP)

(72) Inventors: Yasunari HIKIMA, Kawasaki (JP); Yuma ICHIKAWA, Kawasaki (JP)

(73) Assignee: Fujitsu Limited, Kawasaki-shi (JP)

(21) Appl. No.: 19/326,912

(22) Filed: Sep. 12, 2025

(30) Foreign Application Priority Data
Sep. 18, 2024 (JP) 2024-160866

(51) Int. Cl. G06F 30/27; G06F 111/10

(52) U.S. Cl. CPC G06F 30/27; G06F 2111/10

(57) ABSTRACT

There is provided a non-transitory computer-readable medium storing a calculation program for causing a computer to execute a process. The process includes using a prediction model learned using training data that associates feature data of an input target with an instance parameter of a target to be solved, and generating an estimate of the instance parameter corresponding to feature data, and searching for a solution for variables by using an objective function including variables for a combinatorial optimization problem and the estimate of the instance parameter, and a loss function including a regularization term that changes according to robustness of the variables.

### CROSS-REFERENCE TO RELATED APPLICATION

This application is based upon and claims the benefit of priority of Japanese Patent Application No. 2024-160866 filed on Sep. 18, 2024, the entire contents of which are incorporated herein by reference.

### FIELD

A certain aspect of the present embodiments relates to a non-transitory computer-readable medium, a calculation method, and an information processing device.

### BACKGROUND

Technologies for optimizing complex combinations have been disclosed (see, for example, “Robust Optimization”, Princeton University Press, Vol. 28, May 8, 2009, and Bernhard Korte et al., “Combinatorial Optimization”, Springer, Vol. 1, 2011.)

### SUMMARY

According to an aspect of the present disclosure, there is provided a non-transitory computer-readable medium storing a calculation program for causing a computer to execute a process, the process including: using a prediction model learned using training data that associates feature data of an input target with an instance parameter of a target to be solved, and generating an estimate of the instance parameter corresponding to feature data; and searching for a solution for variables by using an objective function including variables for a combinatorial optimization problem and the estimate of the instance parameter, and a loss function including a regularization term that changes according to robustness of the variables.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 illustrates validation results;

FIG. 2A is a functional block diagram of an overall configuration of an information processing device according to an embodiment;

FIG. 2B is a hardware configuration diagram of an information processing device;

FIG. 3 is a flowchart of an example of an operation of an information processing device during machine learning; and

FIG. 4 is a flowchart of an example of an operation of an information processing device when outputting an approximate solution to an optimization problem using results of machine learning model.

### DESCRIPTION OF EMBODIMENTS

In combinatorial optimization, it is possible to use stochastic programming or robust optimization. However, with stochastic programming or robust optimization, it is difficult to find a solution that achieves the desired robustness.

Optimization problems exist in various industries, including the manufacturing and distribution industries. In particular, a combinatorial optimization problem, which optimizes combinations, is one of the most important areas in the field of optimization. The combinatorial optimization problem is one of the areas actively studied in the fields of OR (Operations Research) and mathematical optimization, and is applied in various fields such as transportation, logistics, communication, and finance.

In these applications, the problem to be solved is formulated as an optimization problem, and decision-making is performed through the solution obtained by optimization. When making this decision, the instance parameters required for the formulation are often unknown. Therefore, a two-stage process is generally used in which the unknown instance parameters are predicted using machine learning models learned from past historical data or statistical models, and decision-making is performed using the optimization problem formulated using the obtained information.

First, stochastic programming will be explained as an example of optimization. Assume that the objective function instance parameter “c” of the optimization problem to be solved is a random variable that varies probabilistically. As an example, to consider a linear objective function, the instance parameter c is assumed to be a coefficient vector. If the probability distribution that this vector c follows is distribution “P”, the optimization problem to be solved may be formulated as an expectation minimization problem of the following formula (1). In the following formula (1), “s.t.” stands for “subject to”. cT is the transpose matrix of c.

$$\begin{matrix}[ Formula 1 ] & \\ {min}_{x} {𝔼}_{c \sim P} [ {c}^{T} x ] s . t . x ∈ χ & ( 1 )\end{matrix}$$

To solve the above optimization problem, it is necessary to evaluate the expectation, which is difficult to evaluate for a general distribution P. Therefore, it is possible to sample N samples {c₁, c₂, . . . , c_{N}} from distribution P, approximate the expectation to the sample mean, and solve the problem of the following formula (2). In this case, by increasing the number of samples N to the limit, the obtained solution asymptotically approaches the optimal solution of the expectation minimization problem.

$$\begin{matrix}[ Formula 2 ] & \\ {min}_{x} \frac{1}{N} {\sum }_{n = 1}^{N} {c}_{n}^{T} x s . t . x ∈ χ & ( 2 )\end{matrix}$$

Next, robust optimization will be explained as another example of optimization. In robust optimization, the distribution P that the coefficient vector c of the objective function follows is unknown, but it is known to be included in a certain region “u” (sometimes called the uncertainty set), and in that situation, the decision is made so that the solution does not deteriorate even if the coefficient vector c takes any value within the uncertainty set u. One formulation for realizing this robust optimization is the optimization of the following formula (3). The min-max in the following formula represents minimizing c as the meaning of x when cTx is maximum in the range of c∈u.

$$\begin{matrix}[ Formula 3 ] & \\ {min}_{x} {max}_{c ∈ u} {c}^{T} x s . t . x ∈ χ & ( 3 )\end{matrix}$$

In robust optimization problems, the uncertainty of the data can be explicitly considered, but solving the min-max type optimization problem of the above formula (3), which includes minimization and maximization, is generally difficult even when using a commercial solver. In addition, since the uncertainty set u is arbitrary, depending on how it is set, there is a possibility that only an overly conservative solution will be obtained.

Here, we summarize the issues of stochastic programming and robust optimization. First, the problems of stochastic programming are as follows:
The distribution that the coefficient vector c follows is generally unknown, making it difficult to calculate the expected value;
Unless a sufficiently large number of samples N is taken, it is difficult to obtain an approximate solution to the problem to be solved; and
When sampling the coefficient vector c is difficult, it is difficult to apply this method.

Next, the problems with robust optimization are as follows:
The setting of the uncertainty set u is arbitrary, and in some cases an overly conservative solution may be obtained, which may not be useful for decision-making; and
In general, min-max optimization problems are difficult to solve.

The problems common to both stochastic programming and robust optimization are as follows:
There is no solver that handles stochastic programming and robust optimization in a unified manner;
There is no solver that achieves the robustness desired by the user beyond min-max type or expectation optimization; and
It is expected that there is a trade-off between expectation evaluation and min-max robustness, and it is difficult to obtain a Pareto solution that includes both with existing solvers.

As described above, it is difficult to find a solution that achieves the desired robustness with stochastic programming or robust optimization. Therefore, in the following embodiment, an example in which a solution that achieves the desired robustness can be found will be described.

### EMBODIMENT

The principle of this embodiment will be explained.

In this example, optimization using the continuous relaxation method will be explained as an example. The continuous relaxation method is a method of solving an optimization problem in which discrete variables are continuously relaxed to continuous variables as a relaxation problem, instead of directly dealing with the combinatorial optimization problem to be solved. Here, combinatorial linear integer programming will be explained as an example.

Normal linear integer programming problems can be expressed as an formula for optimizing the inner product of coefficient vector c and variable vector x, as in the following formula (4). In the following formula (4), x∈{0,1}^{N} is a discrete variable (binary variable). Various practical problems such as the traveling salesman problem, the knapsack problem, the graph coloring problem, and the box packing problem can be expressed as linear integer programming problems. Generally, in f(x;A), x represents the variable to be optimized, and A represents a constant that is not the object of optimization. Therefore, in the following formula (4), the variable x vector is the variable to be optimized, and the coefficient vector c is a constant.

$$\begin{matrix}[ Formula 4 ] & \\ {min}_{x ∈ {\{ 0 , 1 \}}^{N}} f ( x ; c ) = {c}^{T} x , x ∈ {\{ 0 , 1 \}}^{N} , c ∈ {ℝ}^{N} & ( 4 )\end{matrix}$$

In the continuous relaxation method, the discrete variable x∈{0,1}^{N} is relaxed into a continuous matrix expressed by values between 0 and 1. The continuous matrix “p” is the solution to be found. The loss function (cost function) in the following formula (5) is optimized so that each column of the continuous matrix p becomes the optimal solution to the optimization problem. In the following formula (5), a solution is searched for so that the loss function is minimized. If the coefficient vector is known, this relaxation problem is a linear programming problem and can be solved by a general-purpose solver. However, in the optimization problem handled in this embodiment, the coefficient vector c is unknown.

$$\begin{matrix}[ Formula 5 ] & \\ {min}_{p ∈ {[ 0 , 1 ]}^{N}} \hat{f} ( p ; c ) = {c}^{T} p , p ∈ {[ 0 , 1 ]}^{N} , c ∈ {ℝ}^{N} & ( 5 )\end{matrix}$$

Therefore, in this embodiment, a prediction model p(c|D, v) of the instance parameter c is learned from the training data (a set of the feature data of the input target and the instance parameter to be solved) expressed by the following formula (6). The training data is assumed to be obtained in advance. As an example, the feature data of the input target is a feature vector. Next, an estimate of the instance parameter for the unknown new feature vector “v” is generated from the obtained prediction model. The M estimates of the instance parameter c are expressed as the following formula (7).

$$\begin{matrix}[ Formula 6 ] & \\ 𝒟 = {\{ ( {v}_{u} , {c}_{u} ) \}}_{μ = 1}^{L} & ( 6 )\end{matrix}$$

$$\begin{matrix}[ Formula 7 ] & \\ {\hat{c}}_{1} , {\hat{c}}_{2} , … , {\hat{c}}_{M} & ( 7 )\end{matrix}$$

A variable P∈[0,1]^{N×M} for the optimization problem to be solved is introduced, and the optimization problem is solved using the loss function of the following formula (8). In this embodiment, the term on the left side is an objective function including the variable P and the estimated value of the instance parameter c. In the following formula (8), the variable P is the variable to be optimized, and the estimated value of the instance parameter c is a constant.

$$\begin{matrix}[ Formula 8 ] & \\ {min}_{P ∈ {[ 0 , 1 ]}^{N \times M}} \frac{1}{M} {\sum }_{m = 1}^{M} \hat{f} ( {P}_{: , m} ; {\hat{c}}_{m} ) + λ Ω ( P ) & ( 8 )\end{matrix}$$

The term on the right side of the above formula (8), the following formula (9), is a regularization term introduced as an index of robustness of the solution. “λ” is a hyperparameter. λ is a value that satisfies λ>0, and is specified in advance by the user.

$$\begin{matrix}[ Formula 9 ] & \\ Ω {: [ 0 , 1 ]}^{N \times M} \to ℝ & ( 9 )\end{matrix}$$

After searching for a provisional solution that minimizes the loss function of the above formula (8), the model parameters such as hyperparameters are adjusted to other values, and a solution that minimizes the loss function of the above formula (8) is searched for again. For example, the model parameters are updated using a gradient method or the like. In this way, the optimization problem of the above formula (8) is repeatedly solved, and the search for the optimal solution is terminated when the convergence condition is satisfied. As a result, the obtained variable P can be output as a solution that achieves the desired robustness.

In addition, in the process of searching for the optimal solution, the robustness index Ω(P) may be monitored, and the search for the optimal solution may be terminated when the robustness index Ω(P) is equal or less than a threshold value set in advance by the user.

In addition, by optimizing the loss function of the following formula (10) so that each column of the continuous matrix P becomes a solution to the optimization problem, multiple optimization problems can be solved in parallel. For example, by setting the lower limit λ_{LB} and upper limit λ_{UB} of the hyperparameter λ and setting the number of parallel processes “L”, it is possible to automatically simultaneously obtain multiple robust solutions according to the regularization parameters λ|∈{λ_{LB}, λ_{LB}+(λ_{UB}−λ_{LB})/L, . . . , λ_{UB}}.

$$\begin{matrix}[ Formula 10 ] & \\ {min}_{P ∈ {[ 0 , 1 ]}^{N \times M}} \frac{1}{M} {\sum }_{m = 1}^{M} \hat{f} ( {P}_{: , m} ; {\hat{c}}_{m} ) + {λ}_{1} Ω ( P ) , … , {min}_{P ∈ {[ 0 , 1 ]}^{N \times M}} \frac{1}{M} {\sum }_{m = 1}^{M} \hat{f} ( {P}_{: , m} ; {\hat{c}}_{m} ) + {λ}_{L} Ω ( P ) & ( 10 )\end{matrix}$$

Below, a specific example of the index Ω(P) of robustness of a solution will be described. If the value of the objective function fluctuates widely when the solution of the variable P obtained in the optimization process deviates slightly, it can be said that robustness is low. On the other hand, if the value of the objective function fluctuates only slightly even when the solution of the variable P obtained in the optimization process deviates slightly, it can be said that robustness is high. The index Ω(P) is a regularization term that changes according to such robustness.

For example, in min-max robust optimization, the regularization term of the following formula (11) may be introduced for the provisional variable P_{:,m}=∈[0,1]^{N} for the estimated value of the m-th instance parameter c. The regularization term of the following formula (11) represents the maximum value for each objective function “Cost” in the provisional solution. By introducing the following formula (11) as a regularization term, a solution is searched for so as to suppress the objective function Cost to be optimized (minimized) from being most deteriorated in the optimal solution. Each Cost represents “f” in the above formula (8).

$$\begin{matrix}[ Formula 11 ] & \\ {Ω}_{max} ( {P}_{: , m} ) := {max}_{m ∈ [ M ]} \{ {Cost}_{1} ( {P}_{: , m} ) , Cost ( {P}_{: , m} ) , … , {Cost}_{M} ( {P}_{: , m} ) \} & ( 11 )\end{matrix}$$

Alternatively, a regularization term in the following formula (12) may be introduced. The regularization term in the following formula (12) represents the sample variance of each objective function Cost in the provisional solution. By introducing the following formula (12) as a regularization term, a solution is searched for so as to reduce the variation of the cost function for each problem. In the following formula (12), the part in the following formula (13) represents the average value. In the following formula (12), “Var” represents the variance.

$$\begin{matrix}[ Formula 12 ] & \\ Ω ( {P}_{: , m} ) := Var [ \{ {Cost}_{1} ( {P}_{: , m} ) , {Cost}_{2} ( {P}_{: , m} ) , … , {Cost}_{M} ( {P}_{: , m} ) \} ] = \frac{1}{M} {\sum }_{i = 1}^{M} {( {Cost}_{i} ( {P}_{: , m} ) - \overline{Cost ( {P}_{: , m} )} )}^{2} & ( 12 )\end{matrix}$$

$$\begin{matrix}[ Formula 13 ] & \\ \overline{Cost ( {P}_{: , m} )} & ( 13 )\end{matrix}$$

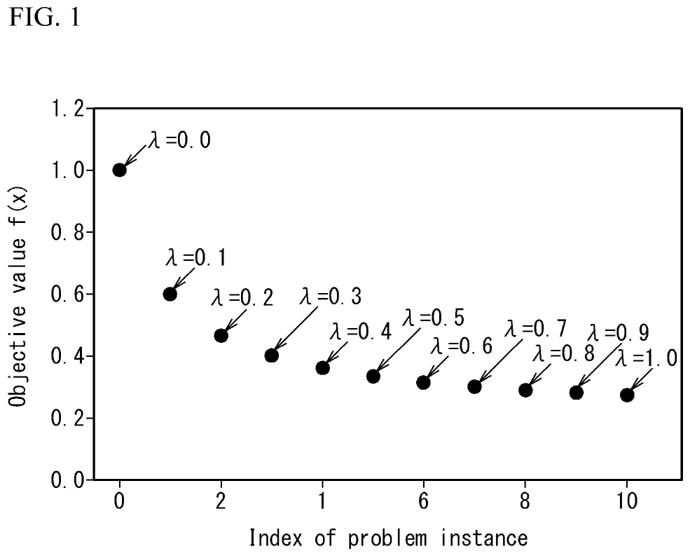

FIG. 1 illustrates the objective function values and robustness when λ is changed from 0.1 to 1.0 in increments of 0.1. In FIG. 1, the vertical axis represents the objective function value. In FIG. 1, the smaller the loss function in the above formula (8) is, the larger the value becomes. Therefore, in FIG. 1, the larger the value of the vertical axis, the better the objective function is obtained. In FIG. 1, the horizontal axis represents robustness. The larger the value on the horizontal axis, the larger 2. Therefore, the higher the value on the horizontal axis, the higher the robustness.

From the results in FIG. 1, it can be seen that the larger the regularization term, the higher the robustness, while the instance objective function value decreases. On the other hand, it can be seen that the smaller the regularization term, the higher the instance objective function value, while the robustness decreases. From the above, the user can set the hyperparameters so as to obtain the robustness that the user desires.

As described above, by defining the index Ω(P) that measures robustness, it is possible to easily integrate expectation optimization, min-max robust optimization, and user-specified robust optimization. Note that multiple different Ω(P) may be used as an index that measures robustness. For example, both the above formula (11) and the above formula (12) may be added as regularization terms.

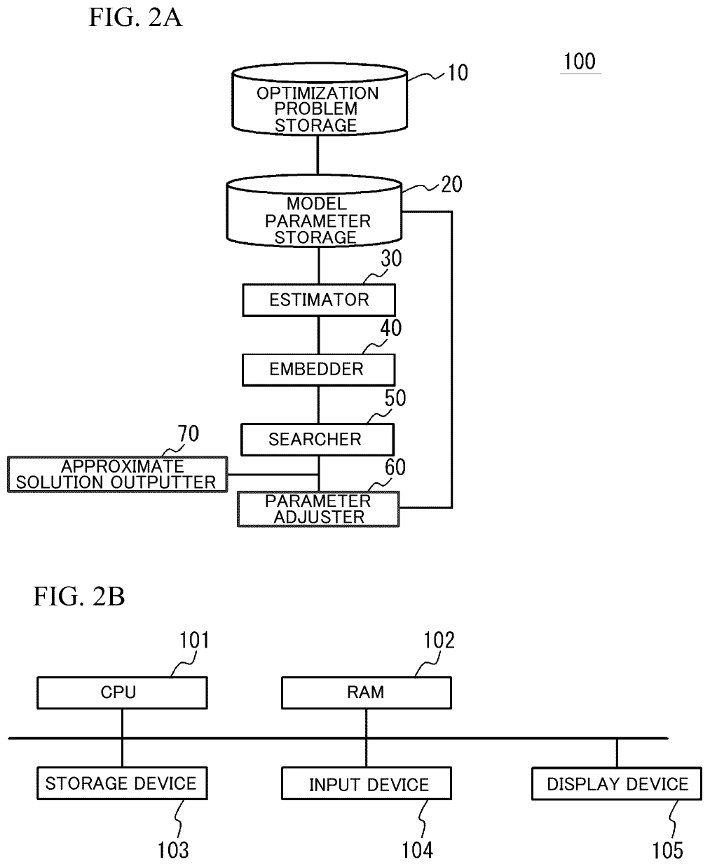

Next, the device configuration for realizing the above solution principle will be described. FIG. 2A is a functional block diagram of an overall configuration of an information processing device 100 according to an embodiment. The information processing device 100 is a server for optimization processing, or the like. As illustrated in FIG. 2A, the information processing device 100 functions as an optimization problem storage 10, a model parameter storage 20, an estimator 30, an embedder 40, a searcher 50, a parameter adjustor 60, an approximate solution outputter 70, and so on. The information processing device 100 functions as a machine learning device during machine learning, and functions as a determination device during determination.

FIG. 2B is a hardware configuration diagram of the information processing device 100. As illustrated in FIG. 2B, the information processing device 100 includes a CPU 101, a RAM 102, a storage device 103, an input device 104, a display device 105, and the like.

The CPU 101 is a central processing unit. The CPU 101 includes one or more cores. The RAM (Random Access Memory) 102 is a volatile memory that temporarily stores the program executed by the CPU 101 and the data processed by the CPU 101. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a calculation program. The input device 104 is a device for a user to input necessary information, such as a keyboard or a mouse. The display device 105 is a display device that displays the sampling results output by the approximate solution outputter 70 on a screen. Each part of the information processing device 100 is realized by the CPU 101 executing the calculation program. Note that each part of the information processing device 100 may be hardware such as a dedicated circuit.

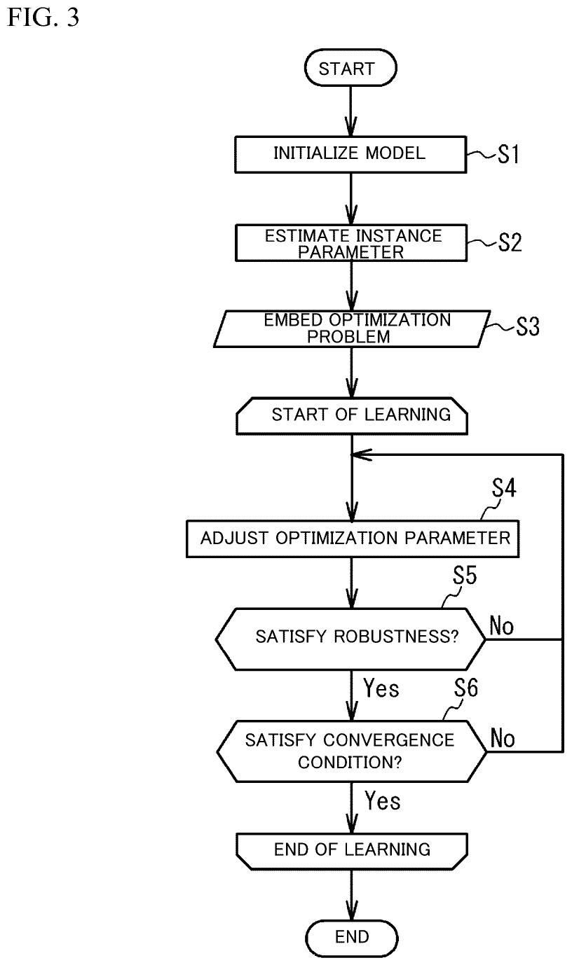

FIG. 3 is a flowchart of an example of the operation of the information processing device 100 during machine learning. As illustrated in FIG. 3, the searcher 50 initializes the model (step S1). Specifically, the searcher 50 sets the model parameters stored in the model parameter storage 20 to predetermined initial values.

The estimator 30 then uses the training data to learn a prediction model p (c|D, v) of the instance parameter c, and generates an estimate of the instance parameter for an unknown new feature vector v from the obtained prediction model (step S2).

The embedder 40 then embeds the optimization problem stored in the optimization problem storage 10 (step S3). This results in the loss function expressed by the above formula (8).

The searcher 50 then starts machine learning. The parameter adjustor 60 adjusts the model parameters for optimization (step S4). By executing step S4, a solution that minimizes the loss function of the above formula (8) is searched for using the adjusted model parameters. The parameters here include, for example, the hyperparameter 2. When step S3 is executed for the first time, no adjustment of the model parameters is performed.

Next, the searcher 50 determines whether or not the robustness condition is satisfied (step S5). For example, it is determined whether or not the value of Ω(P) when the solution is searched for in step S4 is equal to or less than a preset threshold. If the determination in step S5 is “No”, the process is executed again from step S4.

Next, the searcher 50 determines whether or not the convergence condition is satisfied (step S6). For example, it is determined whether or not the loss function of the above formula (8) is no longer smaller than a specified value even when step S6 is executed repeatedly. If the determination in step S6 is “No”, the process is executed again from step S4.

If the determination in step S6 is “Yes”, the execution of the flowchart ends. In this case, the model parameter storage 20 stores the model parameters when the loss function of the above formula (8) is the smallest.

The machine learning of FIG. 3 makes it possible to obtain a machine learning model that minimizes the loss function of the above formula (8). The machine learning model (model parameters) is stored in the model parameter storage 20.

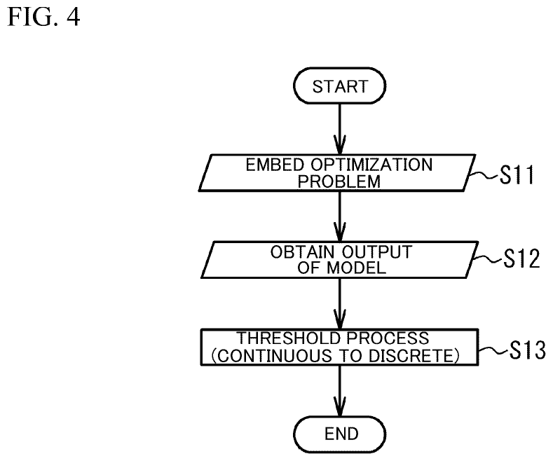

FIG. 4 is a flowchart of an example of the operation of the information processing device 100 when outputting an approximate solution to an optimization problem using the results of the machine learning model obtained by the machine learning of FIG. 3. As illustrated in FIG. 4, the embedder 40 embeds the optimization problem (step S11).

Next, the approximate solution outputter 70 acquires the output of the machine learning model (step S12).

Next, the approximate solution outputter 70 performs threshold processing on the optimal solution output by the machine learning model (step S13). For example, a threshold is set for each value output by the machine learning model to binarize the value. For example, when converting each value into two values of 0 and 1, the threshold is set to 0.5, and values greater than 0.5 are set to 1, and values less than 0.5 are set to 0.

In the above example, the estimator 30 is an example of an estimator that generates estimates of instance parameters corresponding to feature data using a prediction model learned using training data that associates feature data of an input target with instance parameters to be solved. The searcher 50 is an example of a searcher that searches for a solution to a variable using an objective function including variables and estimates of instance parameters for a combinatorial optimization problem, and a loss function including a term that represents an index related to the robustness of the variable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium storing a calculation program for causing a computer to execute a process, the process comprising:
using a prediction model learned using training data that associates feature data of an input target with an instance parameter of a target to be solved, and generating an estimate of the instance parameter corresponding to feature data; and
searching for a solution for variables by using an objective function including variables for a combinatorial optimization problem and the estimate of the instance parameter, and a loss function including a regularization term that changes according to robustness of the variables.

2. The non-transitory computer-readable medium according to claim 1,
wherein the feature data is a feature vector, and
wherein the instance parameter is a vector coefficient of the feature vector.

3. The non-transitory computer-readable medium according to claim 2,
wherein as the regularization term, a maximum value among each value of the objective function in provisional solutions obtained during searching for the solution of the variable is used.

4. The non-transitory computer-readable medium according to claim 2,
wherein as the regularization term, a sample variance of each objective function in the provisional solutions obtained during searching for the solution of the variable is used.

5. The non-transitory computer-readable medium according to claim 1,
wherein as the loss function, a loss function is used in which each element of a matrix obtained by relaxing discrete variables to be optimized to a continuous matrix becomes a discrete optimization problem.

6. A calculation method implemented by a computer, the method comprising:
using a prediction model learned using training data that associates feature data of an input target with an instance parameter of a target to be solved, and generating an estimate of the instance parameter corresponding to feature data; and
searching for a solution for variables by using an objective function including variables for a combinatorial optimization problem and the estimate of the instance parameter, and a loss function including a regularization term that changes according to robustness of the variables.

7. The method according to claim 6,
wherein the feature data is a feature vector, and
wherein the instance parameter is a vector coefficient of the feature vector.

8. The method according to claim 7,
wherein as the regularization term, a maximum value among each value of the objective function in provisional solutions obtained during searching for the solution of the variable is used.

9. The method according to claim 7,
wherein as the regularization term, a sample variance of each objective function in the provisional solutions obtained during searching for the solution of the variable is used.

10. The method according to claim 6,
wherein as the loss function, a loss function is used in which each element of a matrix obtained by relaxing discrete variables to be optimized to a continuous matrix becomes a discrete optimization problem.

11. An information processing device comprising:
a memory; and
a processor coupled to the memory and the processor configured to execute a process, the process comprising:
using a prediction model learned using training data that associates feature data of an input target with an instance parameter of a target to be solved, and generating an estimate of the instance parameter corresponding to feature data; and
searching for a solution for variables by using an objective function including variables for a combinatorial optimization problem and the estimate of the instance parameter, and a loss function including a regularization term that changes according to robustness of the variables.

12. The information processing device according to claim 11,
wherein the feature data is a feature vector, and
wherein the instance parameter is a vector coefficient of the feature vector.

13. The information processing device according to claim 12,
wherein as the regularization term, a maximum value among each value of the objective function in provisional solutions obtained during searching for the solution of the variable is used.

14. The information processing device according to claim 12,
wherein as the regularization term, a sample variance of each objective function in the provisional solutions obtained during searching for the solution of the variable is used.

15. The information processing device according to claim 11,
wherein as the loss function, a loss function is used in which each element of a matrix obtained by relaxing discrete variables to be optimized to a continuous matrix becomes a discrete optimization problem.
